(19) United States
(12) Patent Application Publication
(10) Pub. No.: US 2025/0289695 A1
(43) Pub. Date: Sep. 18, 2025

(54) DEVICE FOR INVERTING ROLL CONTAINERS, USE AND METHOD

(71) Applicant: Deutsche Post AG, Bonn (DE)

(72) Inventor: Thomas Heintz, Leudersdorf (DE)

(21) Appl. No.: 19/074,815

(22) Filed: Mar. 10, 2025

(30) Foreign Application Priority Data
Mar. 12, 2024 (DE) 10 2024 107 063.3

(51) Int. Cl. B66F 9/12

(52) U.S. Cl. CPC B66F 9/125

(57) ABSTRACT

An apparatus and method for inverting roll containers and for attachment to fork arms of an industrial truck, includes an attachment portion for attachment to the fork arms and a rotating portion which is revolvably mounted on the attachment portion, wherein the rotating portion includes two fork elements for engaging in a base portion of a roll container, and wherein a distance between the two fork elements is provided, and a length of the two fork elements is provided, and the length is at least twice as great as the distance, and the rotating portion includes a spacer element for spacing the two fork elements relative to a floor.

The present application is based upon and claims the right of priority to DE Patent Application No. 10 2024 107 063.3, filed Mar. 12, 2024, the disclosure of which is hereby incorporated by reference herein in its entirety for all purposes.

The invention relates to a device for inverting roll containers and a method for inverting roll containers.

Roll containers are rollable trolleys, for example transport trolleys, container trolleys, carts or the like. Roll containers can be stacked. Roll containers can be stacked in a particularly space-saving manner if a roll container to be stacked on top is rotated upside down or inverted before being placed on the roll container below. This is also referred to as rotational stacking. Problems arise when roll containers are too heavy to be inverted manually. Devices for this purpose are known, for example lifting mechanisms which can grip, lift, rotate and lower a roll container. Improvements to the inversion device or method are required.

On this basis, the object of the invention is to provide a device or a method in order to lower the costs of inversion and to achieve ergonomic improvements.

This object is achieved by the subject matter of the independent patent claims. Preferred developments of the invention are found in the dependent claims.

The object is achieved by a device for inverting roll containers and for attachment to fork arms of an industrial truck, in particular a pallet stacking truck, stacker and/or forklift truck. The device as proposed has an attachment portion for attachment to the fork arms and a rotating portion which is mounted rotatably or revolvably on the attachment portion, wherein the rotating portion has two fork elements for engaging in a base portion of a roll container or for taking up the base portion with the fork.

It may be provided that a distance between the two fork elements is provided, and a length of the two fork elements is provided, and the length is at least twice as great as the distance. Alternatively or additionally, it is provided that the rotating portion has a spacer element for spacing the two fork elements relative to a floor or the ground.

In other words, for example, an apparatus is proposed which can be affixed to the lifting tool of a stacker, forklift truck and/or pallet truck and is intended or designed for inverting roll containers, for example container trolleys. The apparatus has a portion for attachment to the lifting tool. The apparatus has a further portion including a fork or at least two projections in order to engage, by this means, in a roll container. The two portions are attached together in a rotatable/revolvable manner, so that, essentially, a rotatable fork is obtained for a generally non-rotatable lifting tool. The invention is characterized in particular in that the distance between the projections forming the fork can be minimized, for example the gap between the projections is at least half as narrow as it is long. It is also possible for the further portion to have a projection so that its fork is located at a distance from the ground or is at the correct height for roll containers.

The invention advantageously implements the concept of an optimally space-saving device which can be affixed to apparatuses which are typically used in logistics and have fork arms, conventionally industrial trucks such as stackers, forklift trucks, pallet trucks, etc., and thus renders them capable of inverting roll containers. The device is thus a low-maintenance and ergonomic aid, which is cost-effective to provide, for inverting the roll containers. Despite the space-saving nature of the device, it is safe to use for inversion due to the attachment to the fork arms.

Industrial trucks or factory trucks are conveying means used at ground level for transporting goods at least substantially horizontally. The industrial trucks in question herein have forks or fork arms. An industrial truck is, in particular, drivable or movable on the floor. It may be a pallet stacking truck, reach truck, multidirectional stacker, narrow-aisle stacker, counterbalanced stacker, low-level order picker, high-level order picker, forklift truck and/or other factory trucks mentioned in the VDI [Verein Deutscher Ingenieure—Association of German Engineers] Standard VDI 3586 dated September 2022. The industrial truck typically has two fork arms with which goods or pallets can be taken up and lifted. The fork arms can be adjusted at least upwards and downwards. The fork arms generally run at least substantially parallel to and at a distance from each other in order to be able to slide under or into the pallets and to be able to reach appropriately far under the pallets or goods and lift them in a stable manner.

The attachment portion is to be understood as a part, intended for attachment to the fork arms, of the device. The attachment portion may contain or be produced from metal, in particular steel and/or aluminium. The attachment portion may be a welded construction in order to be robust. The attachment portion may be designed to be set down on the floor, in particular independently of fork arms, and in particular together with the rotating portion, for example so as to be subsequently picked up or taken up again with the fork in a simple manner by an industrial truck. The attachment portion may have one or more feet for setting down on the floor. Alternatively or additionally, the spacer element may be provided or be suitable for setting down on the floor. The attachment portion may have a rotary bearing or a part of a rotary bearing in order to be revolvably connected to the rotating portion.

The rotating portion is to be understood as a (further) part, which can be rotated relative to the attachment portion, of the device. The rotating portion may contain or be produced from metal, in particular steel and/or aluminium. The rotating portion may be a welded construction, in particular including the fork element(s), support and/or spacer element(s), in order to be robust. The rotating portion may be designed to be set down on the floor, in particular independently of fork arms, and in particular together with the attachment portion. The rotating portion may have one or more feet for setting down on the floor. Alternatively or additionally, the spacer element may be provided or be suitable for setting down on the floor. The rotating portion may have a/the rotary bearing or a part of a/the rotary bearing in order to be revolvably connected to the attachment portion.

The rotating portion is fixed to the attachment portion so as to be, in particular, revolvable, rotatable or pivotable, in particular about a/the axis of rotation. A/the rotary bearing may be provided for this purpose. The rotary bearing may have a shaft guided in one or more bushings. The rotary bearing may have one or more rolling bearings. The rotary bearing may have one or more plain bearings, in particular plastic material plain bearings. The rotary bearing fixes the rotating portion and the attachment portion preferably to each other in the axial direction or along the axis of rotation. Preferably, the rotating portion can be revolved back and forth by at least one full revolution. More preferably, the rotating portion can be revolved back and forth by at least half a revolution. In particular, the rotating portion can be revolved back and forth by a plurality of revolutions. It is also conceivable that the rotating portion is only revolvable in one direction, wherein the other direction is blocked, optionally selectively blocked. A locking means may also be provided, which selectively blocks the rotating portion from revolving relative to the attachment portion, for example when a roll container is taken up with the fork and lifted, so that it does not inadvertently rotate.

The distance between the two fork elements is to be understood as being transverse or perpendicular to the length or extent of the fork elements. The length is preferably to be understood as being along the main direction of extent of the fork elements. The length preferably extends away from the attachment portion and/or along a/the axis of rotation about which the rotating portion can be revolved. Finally, according to a proposed configuration of the invention, the fork elements are to be located markedly closer together than they extend in length in order to achieve stable engagement or to be able to take up items with the fork in a stable manner.

The spacer element is preferably a portion of the rotating portion which is attached thereto or integrally moulded therewith. The object of the spacer element, as proposed, is to hold the fork elements away from the floor or to hold them at a predetermined/the correct height in order to take up a roll container with the fork. The spacer element may also be understood as a foot. The spacer element may be adjustable in length.

The roll container preferably has a base portion and at least two opposite wall portions. The wall portions are preferably arranged at least substantially parallel to each other. The wall portions preferably adjoin or are fixed to the base portion. The wall portions extend at least substantially perpendicularly from the base portion. Rollers, for example pivotable or rotating rollers, in particular four rollers, may be provided on the underside, in particular fixed to the base portion. The wall portions and the base portion may be arranged in a U shape. This allows two of the roll containers to be rotationally stacked in an effective manner since it is possible for the U shapes to interlock. To save weight, the base portion may have a mesh and/or contain or be produced from plastic material.

A roll container is preferably provided with one or more, for example two, engagement openings in the region of the base portion or in the base portion. The engagement openings may be arranged adjacent to one another. The engagement opening(s) is/are provided for fork arms or fork elements, i.e. for the latter to engage or to enter therein. An intermediate web may be arranged between two engagement openings. The intermediate web may separate the engagement openings from each other and provide stability. Preferably, a plurality of engagement openings or intermediate webs are provided on both sides or opposite each other in an aligned manner on the base portion so that a roll container can be taken up with the fork on both sides and/or picked up with the fork from both sides of the roll container through all engagement openings. The engagement openings and/or the intermediate web is/are preferably formed by one or more frame elements on the base portion of the roll container or by the base portion itself.

The device may be advantageously developed in that the length (of the two fork elements) is at least 20 cm. Preferably, the length is at least 40 cm, 50 cm or 60 cm. In particular, the length is 90 cm±20 cm. The length is preferably at most 150 cm or 120 cm. The two fork elements are preferably designed to be identical in length and/or in cross section. The two fork elements are preferably sufficiently long to project beyond the base portion of the roll container on two sides; typical lengths are therefore at least 60 cm or at least 80 cm, in particular at least 10% more than 60 cm or 80 cm. The two fork elements are preferably elongate and/or rod-shaped. Preferably, the two fork elements are metal parts and/or metal profiles, for example circular and/or polygonal profiles, in particular square profiles. In particular, the two fork elements are hollow to save weight. Advantageously, the two fork elements are longer than the roll container so that the fork elements can project through the roll container. In this manner, it is possible to strike an effective balance between stability when holding a roll container and the protruding weight of the device, wherein the device is as compact as possible.

Alternatively or additionally, it may be provided that the distance (between the two fork elements) is at most 20 cm. Preferably, the distance is at least 1 cm or at least 5 cm. The distance may advantageously be provided to be at most or less than 15 cm or 10 cm, in particular the distance is 7.5 cm±5 cm. The two fork elements preferably run at least substantially parallel and/or adjacent to each other. The distance is preferably provided at a plurality of locations between the two fork elements. In this manner, it is possible to strike an effective balance between stability when holding a roll container and the protruding weight of the device, wherein the device is as compact as possible.

A width of the two fork elements may be provided. Preferably, the two fork elements have the same width. The width corresponds in particular to at least half of the distance. The width may also be or correspond to up to four times, three times or twice the distance, or more. In particular, the width is in the range of at least one half to twice the distance. A balance is struck between the stability when holding a roll container, stability of the device itself and the protruding weight of the device. A positive effect on the compactness of the device is also achieved.

The two fork elements may each have a bevel and/or form an entry point for a roll container. The respective bevel may be arranged on the end face of the respective fork element. The bevels of both fork elements may face each other. The bevels may form an entry point for a roll container, in particular an intermediate web on the roll container. This simplifies the ergonomics and allows faster inversion.

Two further fork elements may be provided for engaging in a base portion of a roll container. The two further fork elements may essentially be designed like the two fork elements, i.e. designed in a similar or identical manner, for example with regard to dimensions and/or any other preferred features. The two further fork elements may be arranged opposite the two fork elements in relation to a/the axis of rotation of the rotating portion. For example, a/the rotary bearing is located substantially centrally between the two fork elements and the two further fork elements. The two further fork elements and the two fork elements are preferably arranged at least substantially parallel to one another. In particular, two, three or all of the fork elements are arranged at least substantially parallel to one another. The two further fork elements and the two fork elements may together provide a U shape of the rotating portion or be arranged in a U shape.

The two fork elements and optionally the two further fork elements may be arranged at a distance from a/the axis of rotation of the rotating portion. In particular, the two fork elements and optionally the two further fork elements are arranged or orientated at least substantially parallel to the axis of rotation. The distance to the axis of rotation is, for example, at least 10 cm, preferably at least 15 cm. The two fork elements and optionally the two further fork elements may revolve in an eccentric or off-centre manner about the axis of rotation of the rotating portion or with the rotating portion. This is advantageously provided so that, when the fork elements engage in the base portion, the axis of rotation is shifted towards the centre of gravity of the roll container and/or is arranged at a distance from the base portion.

The two fork elements and the two further fork elements may be at a further distance from one another. The further distance may be at least 5 cm, preferably at least 10 cm. More preferably, the further distance is at least 15 cm and in particular 20 cm±10 cm or 40 cm±20 cm. The further distance may be shorter than the length, i.e. in particular the length of the two (further) fork elements, for example 25% or 50% shorter than the length. This too achieves an advantageous degree of compactness, while increasing functionality and ergonomics. The two further fork elements allow faster inversion since the rotating portion may be reused immediately after inversion without including to be reversed. This also has the result that roll containers are simpler to rotate since they are able, on the whole, to be rotated about or at least in the proximity of their centre of gravity.

The rotating portion may have a support which is mounted rotatably or revolvably on the attachment portion. The two fork elements and/or the two further fork elements may be fixed to the support, for example in order to provide the U shape with the support. The fork elements may be welded to the support in order to provide a particularly stable, captive and therefore secure, and low-maintenance construction. The support preferably extends transversely, in particular substantially perpendicularly, to an axis of rotation.

The rotating portion, in particular the support, may be at a distance of at least 5 cm, preferably at least 10 cm, from the attachment portion. The distance may be provided via a/the rotary bearing. The distance is provided as viewed in particular parallel to the axis of rotation. The distance has the advantageous effect of reducing the risk of being crushed on rotatable parts.

It is possible that the support has or provides the spacer element, in particular two opposite spacer elements. The spacer element is preferably provided by fixing the fork elements to the support at a distance, along the support, from the free end of the support; the spacer element thus remains a protruding portion of the support. The support is advantageously an elongate and/or rod-shaped part, for example a metal part and/or metal profile, for example a circular and/or polygonal profile, in particular a square profile, from which a stable holder for the fork elements and optionally also the spacer elements can thus be obtained in a synergetic and constructionally simple manner. In particular, the support is hollow to save weight. Preferably, in the case of two spacer elements, the spacer elements are oriented parallel to each other and/or pointing away from each other or are directed in different/opposite directions. In this way, the inversion process can be carried out in a versatile manner in two rotational positions of the device, and the spacer elements may be relied upon for adjusting the height of the device above the floor in a simple manner, and it is not required, after a first roll container has initially been inverted, to reverse the device for the next roll container.

The spacer element may have a floor roller, wherein a floor roller axis (i.e. an axis about which the floor roller can rotate when rolling on the floor) may be arranged transversely to a/the axis of rotation of the rotating portion. The floor roller is in particular a heavy-duty roller. A plurality of floor rollers or heavy-duty rollers may also be provided, for example wherein two such rollers may be arranged adjacent to one another and/or coaxially. Particularly advantageously, the floor roller may be integrated into the spacer element. A portion of the floor roller may protrude from the spacer element. The floor roller axis or floor roller may be mounted on two sides in the support. In this manner, a hollow support, which provides the spacer element, can also provide the floor roller and/or its mount with little effort. It is also possible that the spacer element itself is formed from a hollow part, so that the former can also be equipped with the floor roller in a simple manner.

Preferably, in the case of two spacer elements each including one, two or more floor rollers, the floor rollers are oriented pointing away from each other or are directed in different/opposite directions, in particular including at least substantially parallel floor roller axes. In this way, the inversion process can be carried out in a versatile manner in two rotational positions of the device, and the floor rollers may be relied upon for displacing the device in a low-resistance manner along the floor, and it is not necessary, after a first roll container has initially been inverted, to reverse the device for the next roll container.

The floor roller may be adjustable, in particular in order to set the effective length of the spacer element and/or the spacing between the fork elements and the ground. For example, the spacer element can be adjusted away from or towards the axis of rotation. For example, the engagement openings of different roll containers are located at different distances from the floor. In this case, the adjustability of the floor roller and/or the spacer element can also render the device suitable for different roll containers.

The attachment portion may have a slide-in component for fork arms. It is also possible for a plurality of, preferably two, slide-in components to be provided, which are arranged so as to run, in particular, adjacent to one another and/or at least in a substantially parallel manner. The slide-in component is preferably provided for one or both fork arms, or a slide-in component is provided for each fork arm, i.e. in particular with a matching configuration in order to enter into a form fit in at least one direction. In other words, one slide-in component may be provided per fork arm or one slide-in component may be provided for both fork arms. The slide-in component is to be understood in particular as a receptacle or recess for inserting/sliding in one or more fork arms. The slide-in component preferably points along a/the axis of rotation of the rotating portion. One or both fork arms can thus be slid along the axis of rotation, in particular parallel thereto, into the slide-in component(s). Using the slide-in component(s) provides a particularly user-friendly and operational-error-proof way of attaching the device to an industrial truck such as a pallet truck, stacker and/or forklift truck. A user familiar with industrial truck operation immediately recognizes whether a fork arm is slid correctly or incorrectly onto the device if there is a specific slide-in component therefor.

The attachment portion may further be provided with an attachment means. A plurality of attachment means may also be provided. For example, one or more than one attachment means may be provided per fork arm. It is also possible to provide one or more attachment means provided for both fork arms. The attachment means can attach the attachment portion to the fork arms in a releasable manner. For example, the attachment means has a mechanism for reversibly or releasably clamping the fork arms and/or entering into a form fit, in particular a form fit acting along the axis of rotation, with the fork arms. The attachment means may have a screw, which for example is designed for releasably clamping a fork arm slid into a slide-in component. The attachment means or screw may be adjustable or screwable, for example, transversely to the slide-in component, to the axis of rotation and/or to the fork arm and towards the slide-in component and/or the fork arms. The attachment means is designed in particular to provide a releasable force fit and/or form fit of the attachment portion with the fork arms. It is particularly advantageous if the attachment means is designed to releasably secure at least one clamping piece against a fork arm or both fork arms from an underside of the fork arms. For example, by screwing the attachment means, the clamping piece can be adjusted, in particular clamped in position against the fork arm(s) (preferably from underneath) in order to clamp the attachment portion securely. The advantage of “clamping in position from the underside” is that the attached attachment portion remains substantially in a plane with the upper side of the fork arms and the device thus assumes an identical angle to the fork arms each time it is attached. This allows roll containers to be picked up with minimal difficulties and reduces the risk of the fork elements becoming jammed upon introduction. This provides a particularly secure and yet simple-to-operate attachment to industrial trucks. In addition, the device therefore achieves the same position or incline on the fork arms each time it is attached, so that the orientation of the axis of rotation of the rotating portion relative to the floor or the fork arms is always as consistent as possible. This is important and advantageous, allowing the fork elements to be inserted effectively into the engagement openings of the roll container.

Furthermore, a method for inverting roll containers is proposed. In particular, in the method, a device (preferably the device described herein) attached to fork arms of an industrial truck is slid into a base portion of a roll container by means of the industrial truck, wherein, in this process, the device is at least partially or temporarily in contact with a floor and/or rolls on the/a floor, wherein the device is lifted together with the roll container, and wherein the roll container and preferably a rotating portion of the device are rotated or inverted, in particular substantially parallel to the floor and/or to the fork arms and/or about a/the axis of rotation of the device. In this process, the roll container is inverted or rotated in particular by approximately 180°. The roll container may subsequently be placed into another roll container. The device may subsequently be drawn out of the base portion or the engagement openings. In this manner, pairs of rotationally stacked roll containers can then be provided. It may be provided to releasably fasten two rotationally stacked roll containers to each other, for example with strap means or elongate attachment means. In particular, two neighbouring wall portions of the rotationally stacked roll containers are fastened together.

The use of the device for inverting a roll container is further proposed. The roll container may be designed as described in the present document. The roll container has, in particular, a base portion, a wall portion extending at least substantially perpendicularly from the base portion or two wall portions arranged opposite each another. The roll container has, in particular, at least one engagement opening, in particular two engagement openings, in the base portion. Furthermore, a system including the device and one or more roll containers and/or a factory truck is proposed.

In the context of the disclosure, the German abbreviation “bzw.” stands for “beziehungsweise” [or] and is intended, for example, to indicate alternative, essentially equivalent and/or synonymous features, concepts or terms in order to provide a better understanding of the idea or meaning of a feature or term. “Or” may be replaced with “and/or”.

The invention is explained further in detail below on the basis of a preferred exemplary embodiment with reference to the drawings.

In the drawings:

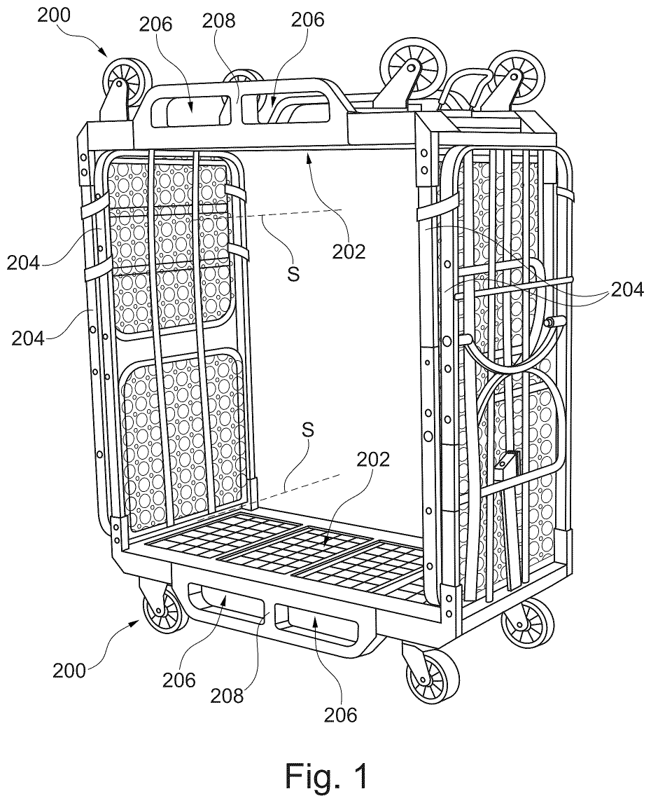

FIG. 1 shows a perspective view of two rotationally stacked roll containers, wherein the upper roll container rests upside down on the lower roll container,

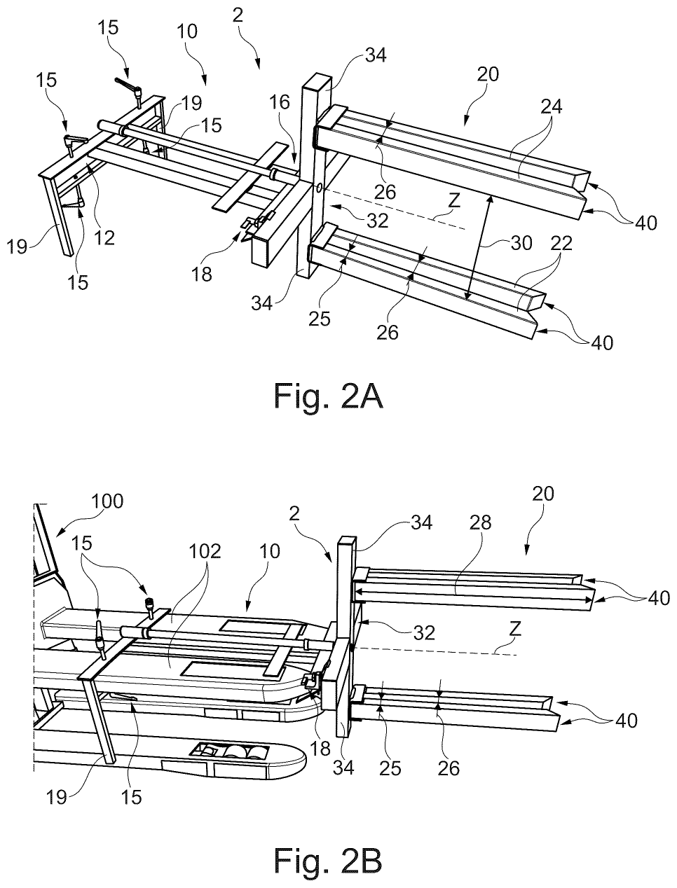

FIG. 2A shows a perspective view of a device for attachment to an industrial truck and for inverting roll containers,

FIG. 2B shows a perspective view of the device from FIG. 2A, which is attached to the fork arms of an industrial truck and is lifted,

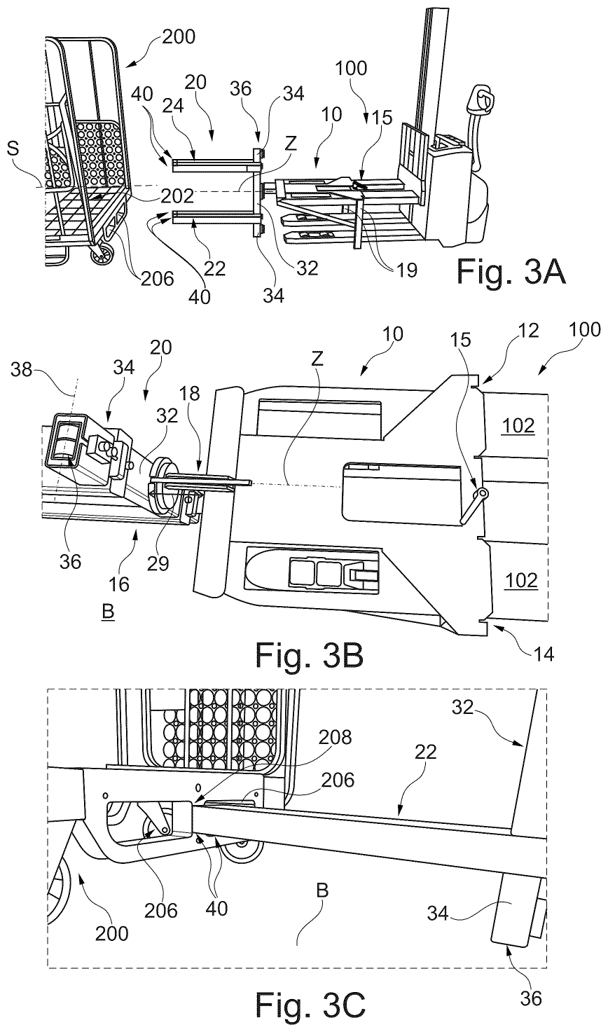

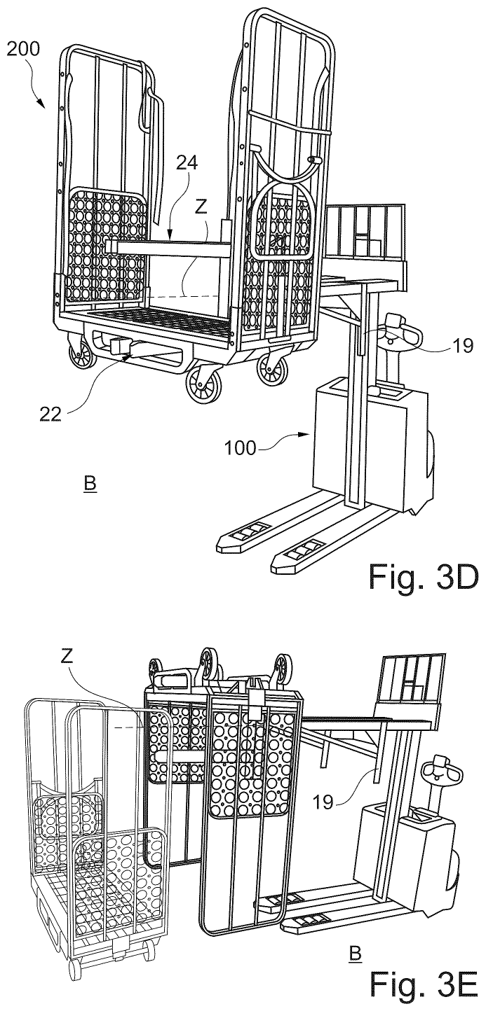

FIG. 3A-E show a device which is intended for inverting roll containers and is attached to the fork arms of an industrial truck, in perspective views from the side adjacent to a roll container (A), from above onto the device (B), from the side shortly before entering into a base portion of the roll container (C), after entering into and lifting the roll container (D) and after the roll container has been inverted (E),

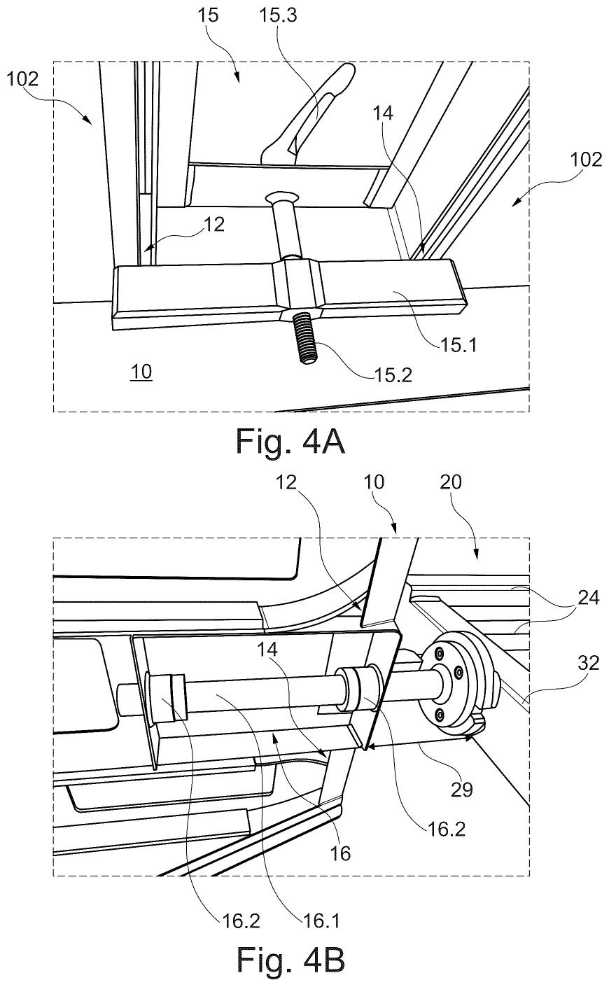

FIG. 4A-B show details of the device from FIG. 3A-D, and

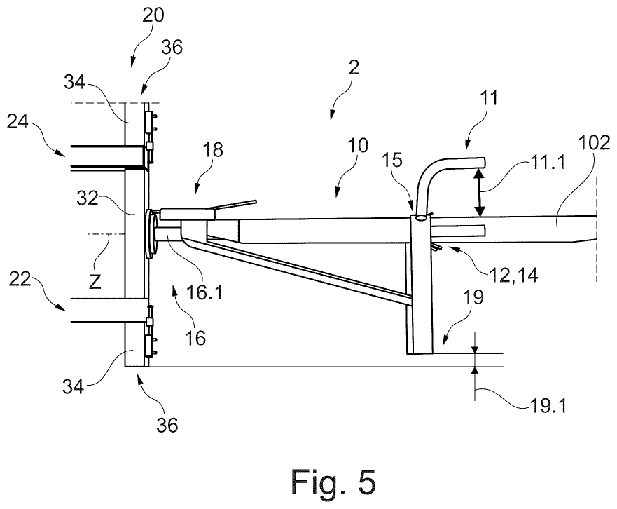

FIG. 5 shows a lateral view of a device for inverting roll containers, which is attached to the fork arms of an industrial truck and has handles and shortened feet.

In FIG. 1, two rotationally stacked roll containers 200 are illustrated, which are known in particular as letter container trolleys or are designed as such. Each of the roll containers 200 has a base portion 202 and two opposite wall portions 204. The wall portions 204 adjoin the base portion 202 and extend at least substantially perpendicularly therefrom. In the present case, the wall portions 204 and the base portion 202 are arranged in a U shape. This allows the roll containers 200 to be rotationally stacked in an effective manner, since it is possible for the U shapes to interlock. The two roll containers 200 are fastened together with strap means.

In the present case, a respective base portion 202 has two adjacent engagement openings 206, for example for fork arms or fork elements. The engagement openings are separated from each other in particular by an intermediate web 208. In the present case, the engagement openings 206 or the intermediate web 208 are located on both sides of or opposite each other in an aligned manner on the base portion 202, so that a roll container 200 can be taken up with the fork on both sides. The engagement openings 206 are formed by one or more frame elements on the base portion 202 of the roll container 200.

The roll containers 200 each have a centroidal axis S, which is located above the base portion 202 and substantially centrally between the wall portions 204. The centroidal axis S is generally located below half the height of the roll container 200. The centroidal axis S runs through the centre of mass of the roll container 200. When the roll container 200 is inverted in a rotational manner substantially about the centroidal axis S, the inversion process requires little force. The present invention seeks herein to provide an ergonomically favourable solution, in particular in the embodiment described below and shown in the appended figures.

FIGS. 2A-B show a device 2 for inverting a roll container 200, in particular one of the roll containers 200 from FIG. 1, and for attachment to fork arms 102 of an industrial truck 100. In FIG. 2A, the device 2 is set down on the floor B on its feet 19 and on a spacer element 34. In FIG. 2B, the device 2 is attached to the fork arms 102 of the industrial truck 100 shown in the figure and is lifted.

The device 2 is at least partially a welded construction. The device 2 is coated and/or painted for protection against corrosion. The device 2 has an attachment portion 10 for attachment to the fork arms 102, and a rotating portion 20, which is mounted on the attachment portion 10 via a rotary bearing 16 so as to be revolvable about an axis of rotation Z. The rotating portion 20 has two fork elements 22 for engaging in a base portion 202 of a roll container 200.

In the device 2, a distance 26 between the two fork elements 22 is provided, and a length 28 of the two fork elements 22 is provided, and the length 28 is at least twice as great as the distance 26. In the present case, the length 28 is a multiple of the distance 26, in particular at least five or ten times the distance. The length 28 is at least 20 cm and the distance 26 is at most 10 cm. A width 25 of the two fork elements 22 is in the range of at least one half to twice the distance 26.

In addition to the two fork elements 22, two further fork elements 24 are provided for engaging in a base portion 202 of a roll container 200. The two further fork elements 24 are designed analogously to the two fork elements 22 in terms of dimensions.

The further fork elements 24 are located, in relation to the axis of rotation Z, opposite the two fork elements 22. The axis of rotation Z is located centrally between them and runs at least substantially parallel to the fork elements 22, 24. The fork elements 22 and the further fork elements 24 are located at a further distance 30 from one another, this distance being shorter than the length 28 and at least 20 cm. The fork elements 22 or 24 are therefore positioned away from the axis of rotation Z since this is where the centre of mass or the centroidal axis S of the roll container 200 is substantially located. This simplifies the inversion process; it would otherwise be more difficult to rotate the roll container 200 about a horizontal axis. The fork elements 22, 24 are each hollow profiles or square profiles made of metal, or more precisely steel.

The rotating portion 20 has a support 32, to which the fork elements 22 and 24 are fixed or welded. The support 32 forms a part of the rotary bearing 16 and is rotatably or revolvably mounted on the attachment portion 10. The rotary bearing 16 has a shaft 16.1 guided in bushings 16.2 on the attachment portion 10, cf. also FIG. 4B. The shaft 16.1 is fixed in a non-rotational manner to the rotating portion 20 or the support 32 and the bushings 16.2 are fixed to the attachment portion 10. The support 32 is at least partially a hollow profile or square profile containing or made of metal, in particular steel and/or aluminium.

The rotating portion 20 has two of the spacer elements 34 for spacing the two fork elements 22 relative to a floor B. In the present case, the support 32 has or forms the spacer elements 34 in the form of spacer elements 34 which are located opposite one another or point away from one another or are directed in opposing directions. The attachment portion 10 further has the feet 19 for setting down. In this manner, in cooperation with one of the spacer elements 34, the device 2 can be set down on the floor B, cf. FIG. 2A.

The two fork elements 22 each have a bevel 40 on an end face or remote from the rotary bearing 16, from the attachment portion 10 and/or from the support 32. The two bevels 40 face each other, in particular to form a tapered entry point for the intermediate web 208. In the present case, the bevels 40 run substantially along the support 32 and/or, if extended, form an axis of intersection, which is arranged transversely or perpendicularly to the axis of rotation Z. In the present case, the two further fork elements 24 are also provided with such bevels 40.

The attachment portion 10 has a slide-in component 12 for the fork arms 102, wherein the slide-in component 12 points along the axis of rotation Z. In the present case, the device 2, or more precisely the attachment portion 10, is provided with parts of a locking means 18 in order to selectively block the rotating portion 20 from revolving on the attachment portion 10. Alternatively or additionally, the rotating portion 20 could have a/the locking means 18 or parts thereof. In FIG. 2, the locking means 18 has a pivotable pin, in particular a pivotable pin which is acted upon by springs or spring tension and can engage in the rotating portion 20 in at least one rotational position, in the present case in two rotational positions, and in this manner can give rise to a form fit about the axis of rotation Z. The locking means 18 or the pin is pivotable in particular transversely to the axis of rotation Z.

The locking means 18, in particular the pin, can be disengaged from the form fit in a manually-operated manner in order to allow the rotating portion 20 to rotate. For example, the free end of the pivotable pin can be pressed down in order to free the opposite end from the form fit. In the present case, in particular when the locking means 18 is released again, the latter can be brought back into the form fit by the action of the spring in a corresponding rotational position.

In the present case, the attachment portion 10 has an attachment means 15 which can act on and clamp the two fork arms 102. In this manner, the device 2 can be releasably attached to the industrial truck 100, as illustrated in FIG. 2B or also FIG. 3B.

The device 2 shown in FIGS. 3A-E is essentially or at least partially designed like the device in FIG. 2. The description of FIG. 2 thus applies to FIGS. 3A-E accordingly. In addition, the device 2 in FIGS. 3A-E is equipped with a slide-in component 12 and an adjacent slide-in component 14, i.e. two slide-in components 12 and 14, one for each fork arm 102. In this manner, improved lateral guidance onto the fork arms 102 is also provided. A further difference between FIG. 2 and FIGS. 3A-E is that, in FIG. 2, the support 32 is essentially X-shaped or cross-shaped, in particular wherein the fork elements 22 and 24 are fixed opposite one another on the support 32, and in particular wherein parts of the locking means 18 are fixed opposite one another on the support 32. In FIGS. 3A-E, the support 32 is not X-shaped, and is rather only I-shaped or elongate in one direction only. The locking means 18 in FIGS. 3A-E has a more compact design than in FIG. 2.

FIGS. 3A-E, in particular FIG. 3B, shows a variant in which the spacer elements 34 each have two floor rollers 36 designed as heavy-duty rollers, wherein a floor roller axis 38 is arranged transversely to the axis of rotation Z. The floor rollers 36 are adjustable, so that the effective length of the spacer element 34 or the distance of the floor rollers 36 from the axis of rotation Z can be changed.

FIGS. 3A-E illustrate or outline in principle a method for inverting a roll container 200 in a step-by-step manner. FIGS. 3A-E show the use of the device 2 for inverting a roll container 200. The device 2 attached to the fork arms 102 of an industrial truck 100 is slid, via two of its fork elements 22, into the base portion 202 of the roll container 200 by means of the industrial truck 100, cf. the transition from FIG. 3A to FIG. 3C, wherein the device 2 in FIG. 3C is yet to start the slide-in process and is shown shortly prior to the beginning of this process. Each of the two fork elements 22 is slid, enters or reaches into one of the engagement openings 206 of the base portion 202. In so doing, the previously mentioned bevels 40 act to centre the intermediate web 208 between the two fork elements 22, causing the roll container 200 itself to be displaced laterally if necessary and thus correcting its position.

During and shortly prior to the slide-in process, the device 2 is at least partially in contact with the floor B or rolls on the floor B, cf. FIG. 3C. In particular, during the slide-in process, a support 32 of the device 2 points substantially perpendicularly to the floor B or vertically, cf. FIG. 3B.

When the fork elements 22 have been slid in fully, the fork elements 22 protrude again, on an opposite side, from the roll container 200 or the base portion 202, out of the opposite engagement openings 206, cf. FIG. 3D. It is thus preferable that the fork elements 22 or 24 are longer than the base portion 202 in order to project beyond the base portion 202 on both sides. Furthermore, the device 2 is then lifted together with the roll container 200, cf. FIG. 3D.

The figure shows that the axis of rotation Z and the centroidal axis S at least substantially coincide, in particular since the fork elements 22 or 24 are arranged in an off-centre manner relative to the axis of rotation Z in accordance with the centre of gravity of the roll container 200, cf. FIG. 3D. This simplifies the rotation of the roll container 200 from an ergonomic perspective since the imbalance relative to the axis of rotation Z is relatively minor.

The locking means 18 can be released after lifting so that the rotating portion 20 can be rotated or revolved relative to the attachment portion 10 in order to invert the roll container 200. The locking means 18 may automatically latch back into position or assume the form fit, for example after rotation.

The roll container 200 and the rotating portion 20 of the device 2 are rotated substantially parallel to the floor B and to the fork arms 102 about the axis of rotation Z of the device 2, cf. the transition from FIG. 3D to FIG. 3E. The inverted roll container 200 can subsequently be stacked in the other roll container 200 shown in FIG. 3E. Finally, in this manner, the arrangement of rotationally stacked roll containers 200 can be achieved, as shown for example in FIG. 1.

FIGS. 4A and 4B show further details of the device from FIGS. 3A-E, in each case substantially on the underside of the attachment portion 10.

FIG. 4A shows how the attachment means 15 clamps the fork arms 102 located in the slide-in components 12, 14. A clamping piece 15.1 is clamped in position on the underside of the fork arms 102 via a screw 15.2. The screw 15.2 can be rotated via an actuating means 15.3, for example a lever, in order to adjust the clamping piece 15.1.

FIG. 4B shows that the rotary bearing 16 has a shaft 16.1 which is guided in two bushings 16.2 located at a distance from one another along the shaft 16.1. The bushings 16.2 each have a plain bearing, in particular a plastic material plain bearing.

The distance between the bushings 16.2 is, in particular, greater than the distance 29 in order to avoid exerting an excessive bending moment on the rotary bearing 16.

It is shown that the shaft 16.1 protrudes from the attachment portion 10 by a distance 29. The distance 29 is, for example, 10 cm±5 cm.

FIG. 5 shows a device 2 for inverting roll containers. The device 2 is attached to the fork arms 102 of an industrial truck. The device 2 is based on the device 2 shown in FIGS. 3A-E and 4, wherein the description of identical reference signs applies accordingly. In the present case, the device 2 has been additionally provided with two handles 11. The handles 11 are each arranged in the region above one of the slide-in components 12, 14 or are fixed to the attachment portion 10, in particular opposite the rotating portion 20.

The handles 11 have, for example, a circular cross section, preferably with a diameter in the range between 15 and 35 mm, in particular in the range between 20 and 30 mm.

In the present case, the underside of the handles 11 is preferably located at a distance 11.1, in the range between 200 and 350 mm, in particular between 250 and 300 mm, from the upper side of the slide-in components 12, 14 or the fork arms 102. The handles 11 may be provided with a plastic material, for example a plastic material coating, for health and safety purposes.

The feet 19 of the device 2 are shortened relative to the spacer elements 34, in particular so that the device 2, when used with the feet 19, is located at a distance from the floor when the spacer element 34 is placed on the floor and the axis of rotation Z runs substantially parallel to the floor. There is thus a distance 19.1 between the spacer elements 36 and the feet 19 or between the feet and the floor. This also allows the device to be set down obliquely in a manner similar to a wheelbarrow and to be picked up manually via the handle 11 so that the feet 19 of the device are at a sufficient distance from the ground.

In particular, the shortened feet 19 have the effect that even sloping or oblique fork arms 102, i.e. fork arms which no longer run parallel to the floor for constructional reasons or for reasons of wear or age, can be moved into the set-down device 2 with minimal collisions.

The distance 19.1 is preferably at least 5 mm and at most 80 mm, more preferably at least 15 mm and at most 60 mm, in particular the distance 19.1 is 40 mm±15 mm.

### LIST OF REFERENCE SIGNS

2 device
10 attachment portion
11 handle
11.1 distance
12 slide-in component
14 slide-in component
15 attachment means
15.1 clamping piece
15.2 screw
15.3 actuating means
16 rotary bearing
16.1 shaft
16.2 bushing
18 locking means
19 foot
19.1 distance
20 rotating portion
22 fork element
24 further fork element
25 width
26 distance between 22 or between 24
28 length of 22 or 24
30 further distance between 22 and 24
29 distance between 10 and 20
32 support
34 spacer element
36 floor roller
38 floor roller axis
40 bevel
100 industrial truck
102 fork arm
200 roll container
202 base portion
204 wall portion
206 engagement opening
208 intermediate web
B floor
S centroidal axis
Z axis of rotation

1. A device for inverting roll containers and for attachment to fork arms of an industrial truck, including an attachment portion for attachment to the fork arms and a rotating portion which is mounted revolvably on the attachment portion,
wherein the rotating portion includes two fork elements for engaging in a base portion of a roll container, and
wherein a distance between the two fork elements is provided, and a length of the two fork elements is provided, and the length is at least twice as great as the distance, and/or the rotating portion includes a spacer element for spacing the two fork elements relative to a floor.

2. The device according to claim 1, wherein two further fork elements, which are arranged opposite the two fork elements in relation to an axis of rotation of the rotating portion, are provided for engaging in a base portion of a roll container.

3. The device according to claim 1, wherein the two fork elements and two further fork elements are arranged at a distance from an axis of rotation of the rotating portion and at least substantially parallel to the axis of rotation.

4. The device according to claim 3, wherein the length is at least 20 cm and/or the distance is at most 10 cm.

5. The device according to claim 1, wherein a width of the two fork elements is in the range of at least one half to twice the distance.

6. The device according to claim 5, wherein the two fork elements and two further fork elements are at a further distance from one another, this distance being at least 20 cm and/or being shorter than the length.

7. The device according to claim 1, wherein the rotating portion includes a support which is mounted revolvably on the attachment portion, wherein the two fork elements and two further fork elements are fixed to the support.

8. The device according to claim 1, wherein the rotating portion is at a distance of at least 5 cm from the attachment portion.

9. The device according to claim 8, wherein a support includes two opposite spacer elements.

10. The device according to claim 1, wherein the spacer element includes a floor roller, wherein a floor roller axis is arranged transversely to an axis of rotation of the rotating portion.

11. The device according to claim 1, wherein the attachment portion includes a slide-in component for the fork arms, wherein the slide-in component points along an axis of rotation of the rotating portion.

12. A method of using the device according to claim 1, comprising:
inverting a roll container with the device, wherein the roll container includes a base portion, wall portions extending at least substantially perpendicularly from the base portion, and at least one engagement opening in the base portion.

13. A method for inverting a roll container, wherein a device attached to fork arms of an industrial truck is slid into a base portion of a roll container by means of the industrial truck and, in this process, the device is at least partially in contact with a floor and/or rolls on the floor, wherein the device is lifted together with the roll container, and wherein the roll container and a rotating portion of the device are rotated substantially parallel to the floor and/or to the fork arms and/or about an axis of rotation of the device, wherein the axis of rotation is shifted towards the centre of gravity of the roll container and is arranged at a distance from the base portion and/or substantially coincides with a centroidal axis of the roll container wherein the device is designed according to claim 1.
